(19) United States
(12) Patent Application Publication
(10) Pub. No.: US 2004/0186888 A1
(43) Pub. Date: Sep. 23, 2004

(54) Method and system for transferring real-time messages between multiple non-connected messaging servers

(75) Inventor: Jonathan Samn, Austin, TX (US)

Correspondence Address: Darcell Walker, 9301 Southwest Freeway, Suite 250, Houston, TX, 77074, US

(73) Assignee: INTERNATIONAL BUSINESS MACHINES CORPORATION, ARMONK, NY

(21) Appl. No.: 10/392,768

(22) Filed: Mar. 19, 2003

(51) Int. Cl. G06F 15/16

(52) U.S. Cl. 709/206; 709/229

(57) ABSTRACT

The present invention allows a client that may have multiple accounts, each on distinct, unconnected messaging servers, to be able to be a relay point between or among those messaging servers. In the system of the present invention, at least one user with accounts on the multiple servers would log on to each server. When that user wants to create a chat conference among people from each of the isolated servers, the relay user can invite each person to the conversation and relay messages from users within the conference on a given server, to the other users from the other server(s). The relay can be implemented easily by “echoing” messages coming from one server to other servers that are connected to the relay client.

### FIELD OF THE INVENTION

The present invention relates to a real-time message transfer system and in particular to a method and system for relaying real-time messages having different formats between multiple, non-connected messaging servers from a central relaying point. Use of the present invention adds functionality to real-time messaging programs to allow a user with accounts on multiple servers to be a relay point between or among different or isolated servers.

### BACKGROUND OF THE INVENTION

There is a wide range of interactive applications implemented on computer systems today. All are characterized by dynamic response to the user. The user provides input to the computer and the application responds quickly. One popular example of interactive applications on personal computers (PCs) is games. In this case, rapid response to the user may mean redrawing the screen with a new picture in between 30 ms and 100 ms. Interactive applications such as games control the speed of their interaction with the user through an internal time base. The application uses this time base to derive rates at which the user input is sampled, the screen is redrawn and sound is played.

As computers have become more powerful and common, it has become important to connect them together in networks. A network is comprised of nodes and links. The nodes are connected in such a way that there exists a path from each node over the links and through the other nodes to each of the other nodes in the network. Each node may be connected to the network with one or more links. Nodes are further categorized into hosts, gateways and routers. Hosts are computer systems that are connected to the network by one link they communicate with the other nodes on the network by sending messages and receiving messages. Gateways are computer systems connected to the network by more than one link. They not only communicate with the other nodes as do hosts, but they also forward messages on one of their network links to other nodes on their other network links. This processing of forwarding messages is called routing. In addition to sending and receiving messages and their routing functions, gateways may perform other functions in a network. Routers are nodes that are connected to the network by more than one link and whose sole function is the forwarding of messages on one network link to the other network links to which it is connected. A network consisting of many network links can be thought of as a network of sub-networks with gateways and/or routers connecting the sub-networks together into what is called an Internet. Today the widely known example of a world wide internet is the so called “Internet” which in 1995 has over 10 million computers connected full time world-wide.

Use of and applications for Internet networks, including the so-called “World Wide Web” (“Web”), increases daily. The Web is a network of computer information storage sites, and each site can include one or more information displays, colloquially referred to as “pages”. Essentially, a Web site presents advertising or other information regarding a particular organization. A person with a computer and a software system referred to as a “browser” can connect the computer to the Internet (and, hence, to the Web), usually via a telephone line, and with the aid of the browser, access the various Web pages.

Another popular feature of the Internet are so-called “chat rooms”. Essentially, a chat room is a computer site that can be accessed (i.e., “logged onto”) simultaneously by many users, with each user being able to input text material intended to be conversational in nature. The conversational input from, e.g., a first user is relayed to the computers of the other users who also happen to be logged onto the chat room, such that the text from the first user is presented to the other users. Then, the other users can respond if they like by inputting text material of their own, and their text material is likewise relayed to the other “occupants” of the chat room, including the first user. In this way, computer users around the globe can undertake dialogues with each other in real time. Further, once a dialog has been established between two particular users, the users can arrange to “meet” in (i.e., transfer to) a private chat room that can be accessed only by the two users, so that the two users can continue their conversation in private.

Instant messaging systems provide for instant, real-time communication between users who are connected to the system through an on-line or electronic networking environment. Examples of instant messaging systems include Yahoo!.®.Messenger, AOL Instant Messenger.^{SM}., and Sametime.™. (“Yahoo!” is a registered trademark of Yahoo! Inc., “AOL Instant Messenger” is a service mark of America Online, Inc., and “Sametime” is a trademark of Lotus Development Corporation.) Such systems are becoming quite popular among users of networks such as the Internet, World Wide Web (hereinafter, “Web”), and internal intranets because they are easy to use and provide a simple way for one user to send a message to another user.

Instant messaging systems provide real-time awareness of who is logged on to a system. Typically, an instant messaging system (hereinafter, “IMS”) user has an address book containing names or nicknames for those people with whom he communicates. The entries in this address book are used for selecting a message recipient. The IMS typically indicates, using a visual cue (such as different icons or different fonts), which of the people are logged on to the system and which are not. For a message to be sent from a sending user to a receiving user, both users must be currently logged on to an IMS (which may be the same IMS, or a different IMS). Otherwise, the system will not allow the sender to send his message. By ensuring that the receiver is available when a message is sent to him, the message can be delivered and presented to the recipient nearly instantly (depending on network delay).

Instant messaging systems are distinguished from e-mail systems in that e-mail is not real-time in nature. E-mail systems merely accept electronic messages, and store them for delivery. There is no real-time awareness of whether the message recipient is currently logged on and able to receive the message. Instead, the message is stored until such time as the user logs on to the e-mail system and receives his waiting messages.

One problem with real-time or instant messaging software is that there are several messaging programs made by different companies and thus different servers are used by the programs not allowing messaging “crossover” among the different servers. At least one person would need to have accounts for all of the different messaging programs, such as Yahoo messenger, AOL Instant Messenger, and MSN Messenger, so everyone that person would want to contact would not have to conform to one program. This would require multiple messaging programs to be installed on at least on computer, or just one program such as Trillian, that is capable of using the different messaging servers, but not for messaging from one account on one server to someone using an account on a different server.

Another problem with real-time messaging is that different companies may use the same program such as IBM Lotus Sametime Client within their companies, but due to security their messaging servers are confined within their own companies. So, if a large team from one company wants to work with another large group from a different company, each person from one company must acquire a temporary account in the other company's real time messaging server. This may be a large use of resources, and thus not cost effective.

There remains a need for an improved instant messaging system that can enable a user to have broader access to multiple non-connected message servers for the purpose of transmitting messages to and receiving messages from these multiple non-connected message servers.

### SUMMARY OF THE INVENTION

It is an objective of the present invention to provide a method and system for the transfer of real-time messages between multiple servers.

It is a second objective of the present invention to provide a method and system for the transfer of real-time messages between non-connected servers.

It is a third objective of the present invention to provide a method and system that can transfer real-time messages between users where each user has a different real-time messaging program.

It is a fourth objective of the present invention to provide system having a relay point for transferring real-time messages between servers.

It is a fifth objective of the present invention to provide a method and system that will allow a user with accounts on multiple servers to be a relay point between or among different isolated servers.

The present invention allows a client that may have multiple accounts, each on distinct, unconnected messaging servers, to be able to be a relay point between or among those messaging servers. In the system of the present invention, at least one user with accounts on the multiple servers would log on to each server. When that user wants to create a chat conference among people from each of the isolated servers, the relay user can invite each person to the conversation and relay messages from users within the conference on a given server, to the other users from the other server(s). The relay can be implemented easily by “echoing” messages coming from one server to other servers that are connected to the relay client.

From the question of security issues, the user with accounts on different servers could open secure connections to the different servers via an encoded tunnel, such as those provided by many companies to their employees who may work at home and use their high-speed internet connections to work from home. This invention will also help with security issues of several separate companies who may use the same real-time messaging program such as Sametime within their companies, and if large teams from each company wish to conference with each other. Instead of everyone from one company getting an account with the other company, one “team lead” with a few backup teams leads, could get accounts with the other company so all confidential conversations MUST go through the leader's relay point.

### DESCRIPTION OF THE DRAWINGS

FIG. 1 is a conventional computing device used for communication between users in a chat room environment via a computer network.

FIG. 2 is a diagram of a computer network over which messages may be transmitted between a user and the reservation center of the present invention.

FIG. 3 shows a configuration of a network containing a chat module.

FIG. 4 is a configuration of a conventional chat room containing several user accounts implement over a computer network.

FIG. 5a is a message board for the chat room for message server A of the configuration shown in FIG. 4.

FIG. 5b is a message board for the chat room for message server B of the configuration shown in FIG. 4.

FIG. 5c is a message board for the chat room for message server C of the configuration shown in FIG. 4.

FIG. 6 is a chat room configuration of the present invention containing a central relay server and several user accounts implement over a computer network.

FIG. 7 is a message board for the chat room configuration shown in FIG. 6.

FIG. 8 is a flow diagram of the operation of the system of the present invention.

### DETAILED DESCRIPTION OF THE INVENTION

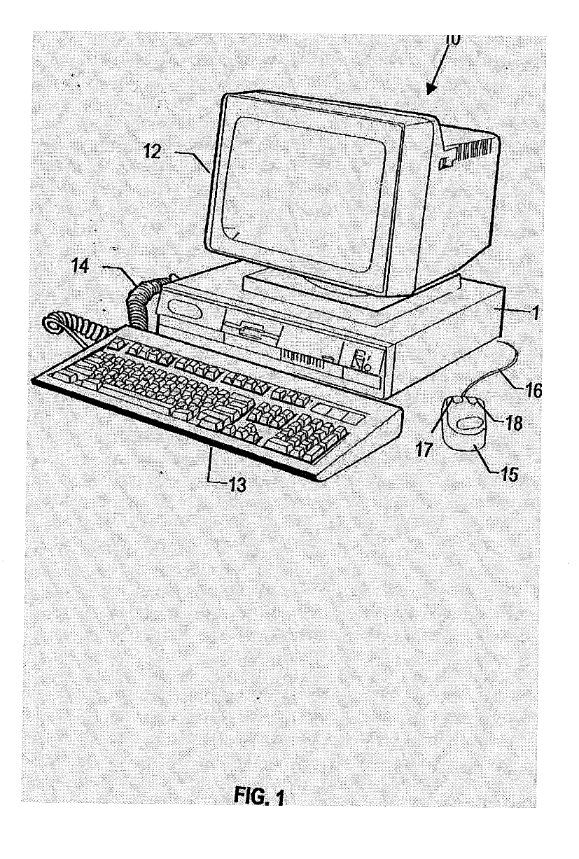

Chat room discussions occur over computing devices, usually personal computers, connected to a communication network. With reference now to FIG. 1, there is depicted a pictorial representation of computing device 10 which may be used in implementation of the present invention. As may be seen, data processing system 10 includes processor 11 that preferably includes a graphics processor, memory device and central processor (not shown). Coupled to processor 11 is video display 12 which may be implemented utilizing either a color or monochromatic monitor, in a manner well known in the art. Also coupled to processor 11 is keyboard 13. Keyboard 13 preferably comprises a standard computer keyboard, which is coupled to the processor by means of cable 14. Also coupled to processor 11 is a graphical pointing device, such as mouse 15. Mouse 15 is coupled to processor 11, in a manner well known in the art, via cable 16. As is shown, mouse 15 may include left button 17, and right button 18, each of which may be depressed, or “clicked”, to provide command and control signals to data processing system 10. While the disclosed embodiment of the present invention utilizes a mouse, those skilled in the art will appreciate that any graphical pointing device such as a light pen or touch sensitive screen may be utilized to implement the method and apparatus of the present invention. Upon reference to the foregoing, those skilled in the art will appreciate that data processing system 10 may be implemented utilizing a personal computer.

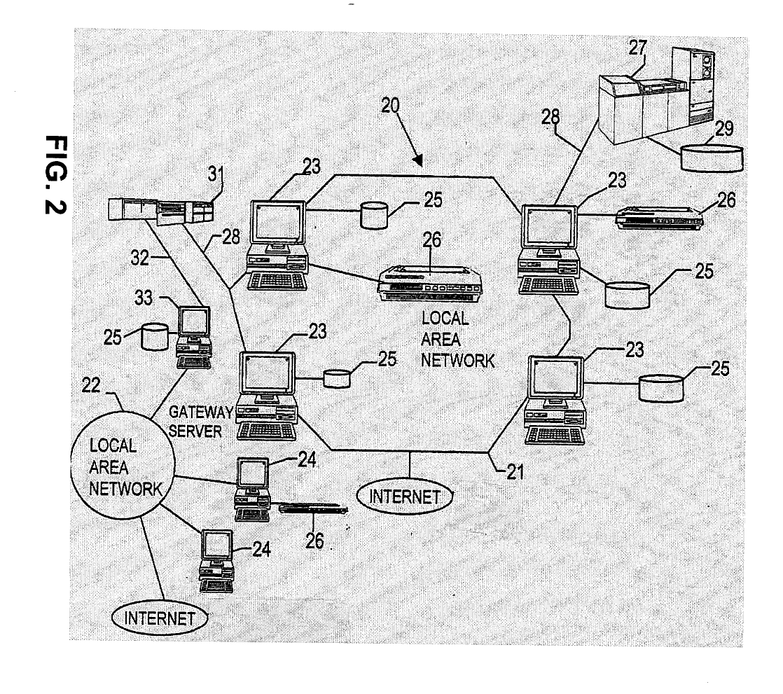

The method of the present invention may be implemented in a global computer network environment such as the Internet. With reference now FIG. 2, there is depicted a pictorial representation of a distributed computer network environment 20 in which one may implement the method and system of the present invention. As may be seen, distributed data processing system 20 may include a plurality of networks, such as Local Area Networks (LAN) 21 and 22, each of which preferably includes a plurality of individual computers 23 and 24, respectively. Of course, those skilled in the art will appreciate that a plurality of Intelligent Work Stations (IWS) coupled to a host processor may be utilized for each such network. Any of the processing systems may also be connected to the Internet as shown. As is common in such data processing systems, each individual computer may be coupled to a storage device 25 and/or a printer/output device 26. One or more such storage devices 25 may be utilized, in accordance with the method of the present invention, to store the various data objects or documents which may be periodically accessed and processed by a user within distributed data processing system 20, in accordance with the method and system of the present invention. In a manner well known in the prior art, each such data processing procedure or document may be stored within a storage device 25 which is associated with a Resource Manager or Library Service, which is responsible for maintaining and updating all resource objects associated therewith.

Still referring to FIG. 2, it may be seen that distributed data processing system 20 may also include multiple mainframe computers, such as mainframe computer 27, which may be preferably coupled to Local Area Network (LAN) 21 by means of communications link 28. Mainframe computer 27 may also be coupled to a storage device 29 which may serve as remote storage for Local Area Network (LAN) 21. A second Local Area Network (LAN) 22 may be coupled to Local Area Network (LAN) 21 via communications controller 31 and communications link 32 to a gateway server 33. Gateway server 33 is preferably an individual computer or Intelligent Work Station (IWS), which serves to link Local Area Network (LAN) 22 to Local Area Network (LAN) 21. As discussed above with respect to Local Area Network (LAN) 22 and Local Area Network (LAN) 21, a plurality of data processing procedures or documents may be stored within storage device 29 and controlled by mainframe computer 27, as Resource Manager or Library Service for the data processing procedures and documents thus stored. Of course, those skilled in the art will appreciate that mainframe computer 27 may be located a great geographical distance from Local Area Network (LAN) 21 and similarly Local Area Network (LAN) 21 may be located a substantial distance from Local Area Network (LAN) 24. That is, Local Area Network (LAN) 24 may be located in California while Local Area Network (LAN) 21 may be located within Texas and mainframe computer 27 may be located in New York.

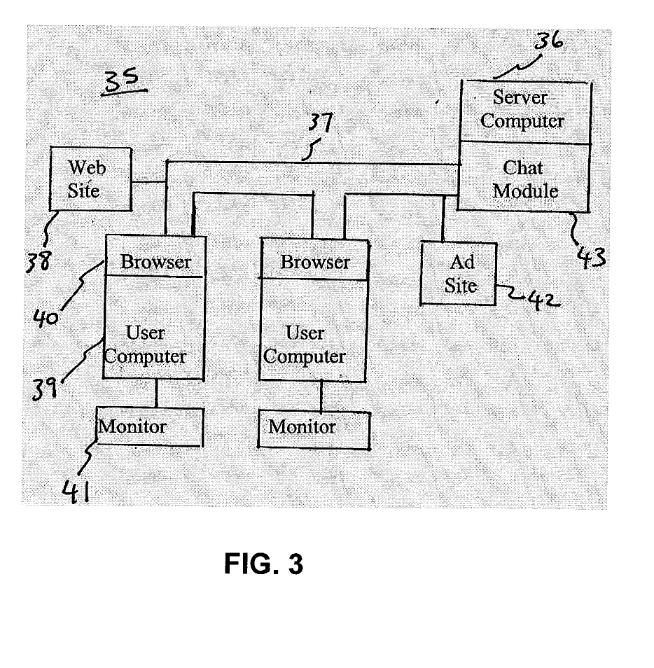

Referring initially to FIG. 3, a chat room system is shown, generally designated 35, which includes a server computer 36, which is part of a computer network. In the preferred embodiment, the server computer 36 is part of the computer network 37 referred to as the Internet, and it can access a portion of the Internet known as the World Wide Web (“Web”). As is well known, the Web includes a plurality of Web sites 38 (only one site 38 shown in FIG. 3). Additionally, plural user computers 39 communicate with the network 37 using respective software-implemented browsers 35 in accordance with well-known principles. As intended by the present invention, the browsers 40 can advantageously be commercial browsers, such as are made by Netscape and Microsoft Corp. Further, each user computer 39 is associated with a respective output device such as a video monitor 41. Moreover, one or more advertising sites 42, each typically implemented by a respective server computer, communicate with the network 37 by well-known means.

As discussed further below, the server computer 36 includes a chat module 43 for facilitating communication between user computers 39 via the network 37, in real time with broadcast programs that establish the subjects of discussion between the user computers 39. Thus, each chat room that is implemented by the chat module 43 relates to a program being broadcast, real-time, over a respective channel. As intended herein, a “broadcast” program means any television or radio program that is delivered on a wide-area basis to plural public recipients by standard wireless broadcast (i.e., from land-based radiofrequency (rf) transmitters), or by cable, or by satellite transmission, or by Internet transmission, or by multicast or intercast. Preferably, the broadcast programs are television programs delivered by cable and/or standard wireless broadcast.

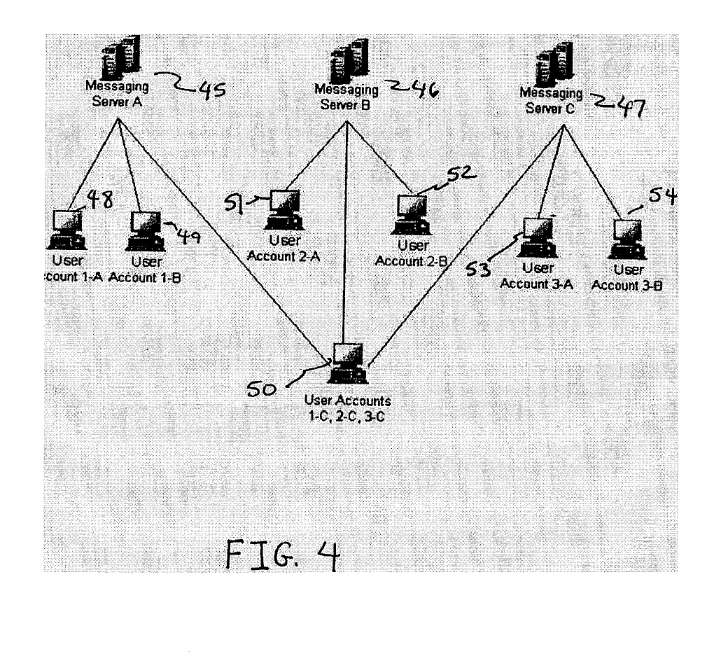

Referring to FIG. 4, shown are conventional configurations for a chat rooms on different servers. In this configuration, there are three messaging servers A, B and C. Numbers 45, 46 and 47 designate these messaging server respectively. Messaging Server A 45 has three users 48, 49 and 50 connected to the chat room for that server. Each user has a separate account 1-A, 1-B and 1-C respectively. Messaging Server B 46 also has three users 50, 51 and 52. Again, each user has a separate account for this server 2-A, 2-B, 2-C. Likewise messaging server 47 has users 50, 53 and 54 with each user having a separate account 3-A, 3-B and 3-C for that messaging server. As shown, user 50 has accounts on each message server. The problem stated earlier is that for user 50 to be able to participate in the chat rooms on the various servers, user 50 must have separate accounts on each server as illustrated in the configurations. Because of the current capabilities of real-time messaging, messages can only involve users connected to a specific messaging server.

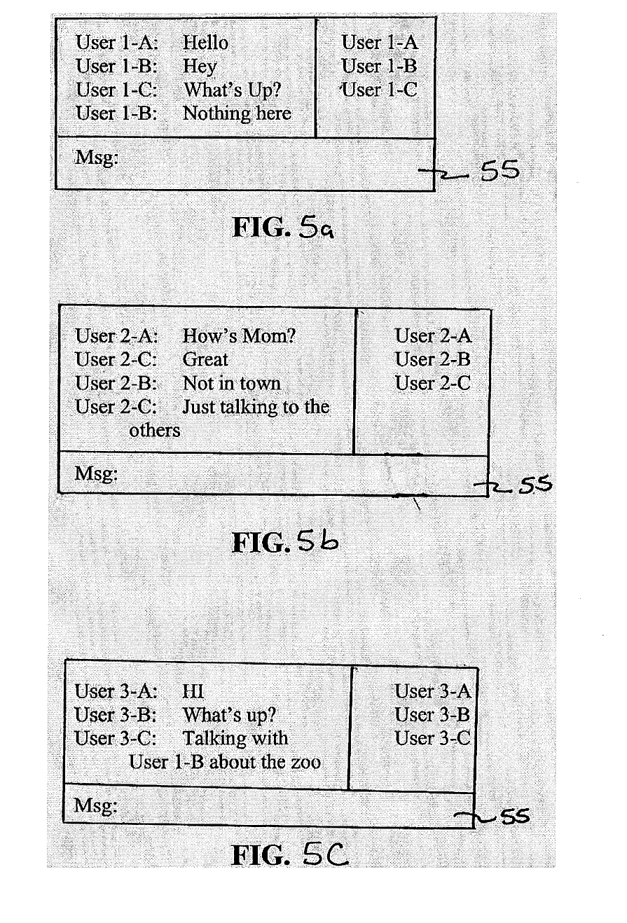

FIG. 5a is a messaging board of the messages in the chat room conversation on messaging server 45. As shown, user 48 has an initial message “Hello”. User 49 responds “Hey”. User 50 response “What's up”? User 49 again enters a message “Nothing here”. The messaging board has a space 55 where each user can enter a message. As previously described, this message is relayed to every user current connected to the chat room on the messaging server. FIG. 5b has a messaging board with comments similar to the comments in FIG. 5a. Likewise, the messaging board in FIG. 5c has comments in the same format as the messaging boards of FIGS. 5a and 5b.

The present invention addresses the limitation of the current capabilities of real-time messaging, in which messages can only involve users connected to a specific messaging server. The present invention is a system involving the transmission of messages from one server to a user not directly connected to that server. The system of the present invention incorporates a system of relaying messages from one server to another through a central relay point. This central is a user that has access accounts on various servers.

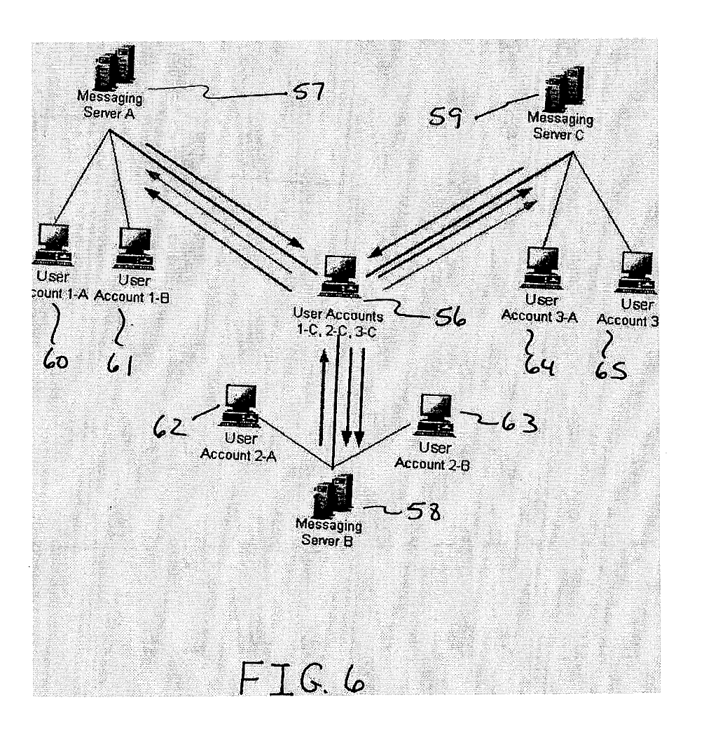

Referring to FIG. 6, shown is a configuration for this system of the present invention. This system comprises a central user 56 that has accounts on three different messaging servers 57, 58 and 59. In the present invention, central user 56 would serve as a relay point for messages from users having accounts on only one messaging server. In this configuration, messaging server 57 has in addition to user 56, users 60 and 61. Users 60 and 61 can only access messaging server 57. Messaging server 58 also has user 62 and 63 in addition to user 56. Messaging server 59 also has user 64 and 65 in addition to user 56.

In practice, the invention has some similarities to a three-way telephone conference call. With these calls, an initial call is originated from the first caller to a first destination. Once that connection has been established, the first caller places the first party on hold and establishes a call with a second party. Depending on the capabilities of a particular system, more calling parties can be added to the call. The parties connected to the telephone conversation can communicate with each other just as if they were directly connected to each other via the originator of the call.

With the present invention, the central user 56 can initiate a chat room discussion that can be accessible to any user connected to any of the three messaging servers. In this system, if a user wanted to participate in a chat room discussion on a server that the user is not connected to, then a message from that user would be received at the central user and echoed to the appropriate server where the actual chat is taking place. In an example, a chat room discussion is held on messaging server 57. User 64 has connection only to server 59. However, the central user 56 is connected to messaging server 57 and 59. A connection of user 64 to the messaging server 57 will be accomplished through a link provided by central user 56.

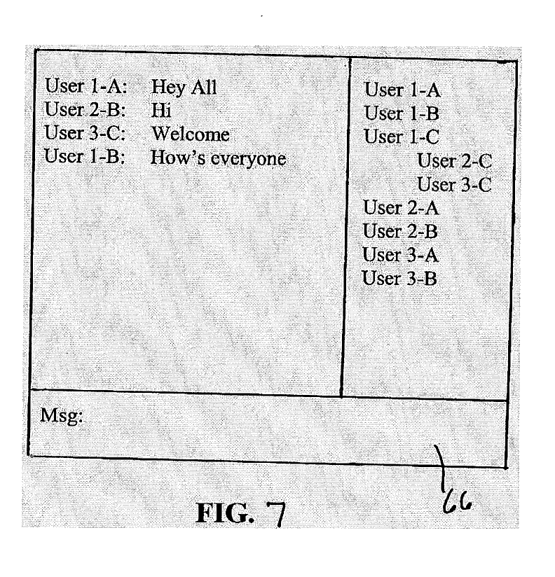

Referring to FIG. 7, there is an illustration of a messaging board 66 for a chat room discussion involving all of the users 56, 60, 61, 62, 63, 64 and 65 in the configuration of FIG. 6. Because there are users connected to each messaging server in the configuration that are connected to the chat room, all three central user accounts are active in this chat. Regardless of the location of the actual chat room, any message sent to the chat room is relayed from the chat room location, through the central user and to the other users connected to the chat.

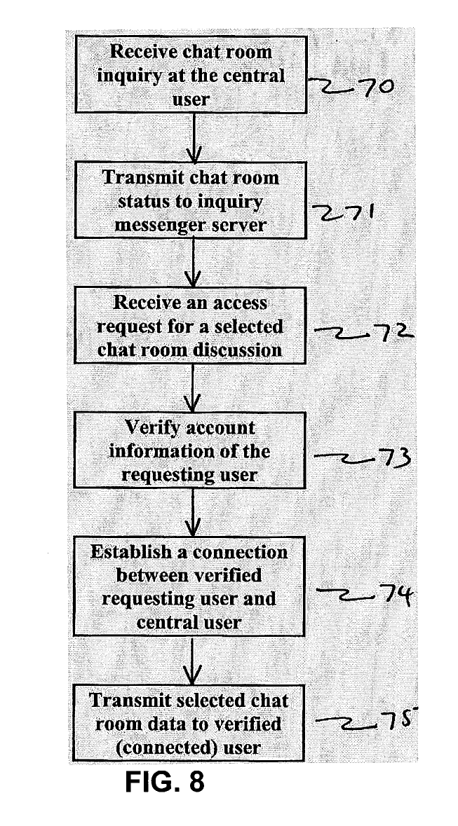

FIG. 8 illustrates the steps in the process of the present invention. As indicated in step 70, the central user 56 receives a chat room status request from a messenger server. This origin of the status request would be a user with an account only on the requesting server that wants to know what chat room discussions are currently accessible on the system. The available chat room discussions would be all discussions currently accessed by the central user 56. After receiving the chat room inquiry, in step 71, the central user would send a chat room status to the messenger server making the request. Messenger server receives the chat room status, the requesting user can view the available chat room discussions. If the user decides to join one the chat room discussions, in step 72, the user would submit an access request to the central user via the messenger server of the requesting user. This request could contain information about the status of the requesting user's account and the selected chat room discussion that the user wants to join. In step 73 the central user verifies the account of the requesting user. This verification could confirm that the requesting has the proper authority or status to access chat rooms beyond those of the messenger server on which the requesting user has an account. Once the central user verifies the status of the requesting user, step 74 establishes a connection between the requesting user and the central user for the purpose of participating in the selected chat room discussion. After the establishment of the connection, step 75 transmits to the connected (requesting) user the contents of the chat room. The transmission can be through an echoing process in which the central user echoes to the connected user the contents of the chat. The connected user can submit comments via the central user connected to the chat. It is possible for the connected user to appear as a separate participant even though this participation is through the central user. Other variations of this system are available but may depend on the features of the systems. In any case, the connected user can remain a part of the chat as long as the central is part of the chat. The central user of a system may give a warning to a connected user prior to termination that the central user may terminate a connection to a certain chat. A system may also have the capability to allow a connected user to have access to more than one chat discussion at the same time via the central user. Ideally, the central user should be able to simultaneously accommodate as many connected users as possible.

It is important to note that while the present invention has been described in the context of a fully functioning data processing system, those skilled in the art will appreciate that the processes of the present invention are capable of being distributed in the form of instructions in a computer readable medium and a variety of other forms, regardless of the particular type of medium used to carry out the distribution. Examples of computer readable media include media such as EPROM, ROM, tape, paper, floppy disc, hard disk drive, RAM, and CD-ROMs and transmission-type of media, such as digital and analog communications links.

1. A system for transferring real-time messages between multiple non-connected devices comprising:
a plurality of computing devices;
a computing network for transmitting messages to and from said computing devices;
interface devices connected to said plurality of computing devices for connecting said devices to said computing network and for interacting with said computing device; and
a central computing capable of interacting with each of said plurality of computing devices for the purposes of relaying messages to said plurality of computing devices.

2. The system as described in claim 1 further comprising at least two messaging servers connected to said computing network and connected to said central user, said messaging servers capable of generating and transmitting real-time messages to said computing devices.

3. The system as described in claim 2 wherein groups of said plurality of computing devices are connected to each of said messaging servers.

4. The system as described in claim 3 further comprising chat room modules contained in each of messaging servers.

5. The system as described in claim 4 wherein said central use has access to said chat room modules on each of said messaging servers.

6. The system as described in claim 4 wherein said computing devices only have direct access to chat room modules on the messaging server to which the computing device has a connection.

7. A method for transferring real-time messages between multiple non-connected devices comprising the steps of:
receiving an access request from a user for access to a messaging server;
transmitting a verification request to the requesting user;
receiving access verification information from requesting user;
verifying user access information;
establishing a connection to requested messaging server through a central user; and
transmitting information to the connected user from the messaging server through the central user.

8. The method as described in claim 7 wherein said verification step further comprises determining whether the user requesting access has authority to access the requested messaging server.

9. The method as described in claim 7 wherein the connection of the user is to a chat room module on the requested messaging server.

10. The method as described in claim 9 wherein said messaging information is transferred from the chat room module on the connected messaging server to the connected user by echoing the messaging server information from the central user to the connected user.

11. The method as described in claim 7 further comprising the step of terminating the access of user connected to a messaging server through a central user.

12. The method as described in claim 7 further comprising the step of broadcasting to the messaging servers connected to the central user, the number of chat room modules to which the central user is currently connected.

13. The method as described in claim 12 further comprising the step of displaying on the connected user's computing device the chat room messaging board for the chat room for which the user is connected through the central user.

14. A computer program product in a computer readable medium for transferring real-time messages between multiple non-connected devices comprising:
instructions for receiving an access request from a user for access to a messaging server;
instructions for transmitting a verification request to the requesting user;
instructions for receiving access verification information from requesting user;
instructions for verifying user access information;
instructions for establishing a connection to requested messaging server through a central user; and
instructions for transmitting information to the connected user from the messaging server through the central user.

15. The computer program product as described in claim 14 wherein said verification instructions further comprise instructions for determining whether the user requesting access has authority to access the requested messaging server.

16. The computer program product as described in claim 14 further comprising instructions for accessing a chat room contained on a messaging server.

17. The computer program product as described in claim 16 further comprising instructions for transferring messaging information from the chat room module on the connected messaging server to the connected user by echoing the messaging server information from the central user to the connected user.

18. The computer program product as described in claim 14 further comprising instructions for terminating the access of user connected to a messaging server through a central user.

19. The computer program product as described in claim 14 further comprising instructions for broadcasting to the messaging servers connected to the central user, the number of chat room modules to which the central user is currently connected.

20. The computer program product as described in claim 19 further comprising instructions for displaying on the connected user's computing device the chat room messaging board for the chat room for which the user is connected through the central user.
